(19) United States
(12) Patent Application Publication
(10) Pub. No.: US 2026/0302977 A1
(43) Pub. Date: Oct. 1, 2026

(54) CONTROL DEVICE AND PHASE ERROR CORRECTION METHOD

(71) Applicant: HONDA MOTOR CO., LTD., Tokyo (JP)

(72) Inventor: Ayano Yoshida, Wako-shi (JP)

(21) Appl. No.: 19/633,014

(22) Filed: Mar. 30, 2026

(30) Foreign Application Priority Data
Mar. 31, 2025 (JP) 2025-058401

(51) Int. Cl. H02P 9/00; B64D 31/18; H02P 9/02; H02P 9/08; H02P 21/22; H02P 21/34

(52) U.S. Cl. CPC H02P 9/009; B64D 31/18; H02P 9/02; H02P 9/08; H02P 21/22; H02P 21/34

(57) ABSTRACT

A control device, which controls a rotating electric machine provided with a resolver that detects a rotation angle of a rotating shaft, includes: a current supply control unit that performs d-axis current supply control, which is control of supplying a d-axis current to the rotating electric machine in a state where the rotating shaft is stopped; a behavior detection unit that detects a behavior of the rotating shaft when the d-axis current supply control is performed; and a correction processing unit that performs, according to the behavior detected by the behavior detection unit, a correction process of correcting a phase error between an actual rotation angle of the rotating shaft and a rotation angle of the rotating shaft indicated by an output signal of the resolver.

### CROSS-REFERENCE TO RELATED APPLICATIONS

This application is based upon and claims the benefit of priority from Japanese Patent Application No. 2025-058401 filed on Mar. 31, 2025, the contents of which are incorporated herein by reference.

### BACKGROUND OF THE INVENTION

### Field of the Invention

The present disclosure relates to a control device and a phase error correction method.

### Description of the Related Art

JP 2009-060752 A discloses an angle error learning device that learns a detection error of a resolver. The resolver detects a rotation angle of a rotating electric machine.

### SUMMARY OF THE INVENTION

It is preferable to suitably detect the rotation angle of a rotating shaft.

The present disclosure has the object of solving the above-described problem.

A first aspect of the present disclosure is characterized by a control device that controls a rotating electric machine provided with a resolver configured to detect a rotation angle of a rotating shaft, the control device comprising: a current supply control unit configured to perform d-axis current supply control that is control of supplying a d-axis current to the rotating electric machine in a state where the rotating shaft is stopped; a behavior detection unit configured to detect a behavior of the rotating shaft when the d-axis current supply control is performed; and a correction processing unit configured to perform, according to the behavior detected by the behavior detection unit, a correction process of correcting a phase error between an actual rotation angle of the rotating shaft and a rotation angle of the rotating shaft indicated by an output signal of the resolver.

A second aspect of the present disclosure is characterized by a phase error correction method for correcting a phase error between an actual rotation angle of a rotating shaft of a rotating electric machine and a rotation angle of the rotating shaft indicated by an output signal of a resolver, the phase error correction method comprising: a control step of causing one or more processors to perform d-axis current supply control that is control of supplying a d-axis current to the rotating electric machine in a state where the rotating shaft is stopped; a detection step of causing the one or more processors to detect a behavior of the rotating shaft when the d-axis current supply control is performed; and a correction step of causing the one or more processors to perform a correction process of correcting the phase error according to the behavior detected in the detection step.

According to the present disclosure, the rotation angle of the rotating shaft can be suitably detected.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram of a moving object;

FIG. 2 is a schematic diagram of a power supply system;

FIG. 3 is a circuit diagram of a PCU;

FIG. 4 is a block diagram of a control device;

FIG. 5A, FIG. 5B, and FIG. 5C are diagrams showing an actual dq current vector plane of a generator and a dq current vector plane recognized by the control device;

FIG. 6 is a flowchart of a zero point correction process;

FIG. 7A and FIG. 7B are diagrams showing the actual dq current vector plane of the generator and the dq current vector plane recognized by the control device;

FIG. 8 is a flowchart of a first correction process;

FIG. 9 is a flowchart of a second correction process;

FIG. 10 is a time chart of a rotational speed of a rotating shaft of the generator, a d-axis current, and a correction value;

FIG. 11A and FIG. 11B are diagrams showing a torque generated in the generator; and

FIG. 12A and FIG. 12B are time charts of the rotational speed of the rotating shaft of the generator and a command value of the d-axis current.

### DETAILED DESCRIPTION OF THE INVENTION

An electric moving object including a power generation device has been developed. The power generation device includes, for example, a gas turbine engine, a generator, and a power control unit (PCU). The output shaft of the gas turbine engine is connected to the rotor of the generator. By the operation of the gas turbine engine, the generator outputs AC power. The PCU converts the AC power output from the generator into DC power and supplies the DC power to a load device or the like.

A rotation sensor, for example, a resolver is attached to a rotating shaft of a rotating electric machine such as a generator or an electric motor. In the case where the resolver is attached to the rotating shaft of the rotating electric machine at a correct angle, there is no error between a zero point (reference point) recognized by a control device that controls the rotating electric machine and a zero point (reference point) of an output signal of the resolver. In this case, there is no phase error between the actual rotation angle of the rotating shaft and the rotation angle indicated by the output signal of the resolver. In contrast, in the case where the resolver is not attached to the rotating shaft of the rotating electric machine at a correct angle, an error occurs between the zero point (reference point) recognized by the control device and the zero point (reference point) of the output signal of the resolver. In this case, a phase error occurs between the actual rotation angle of the rotating shaft and the rotation angle indicated by the output signal of the resolver. The phase error between the actual rotation angle of the rotating shaft and the rotation angle indicated by the output signal of the resolver is herein also referred to as “phase error of the resolver” or simply “phase error”.

In order to control the rotating electric machine, it is necessary to eliminate the phase error of the resolver. The process of eliminating the phase error of the resolver is referred to as zero point correction. The zero point correction is also referred to as reference point correction, origin correction, resolver learning, or the like. The present disclosure enables zero point correction of a rotating electric machine provided in a moving object to be suitably performed.

### 1. Moving Object 100

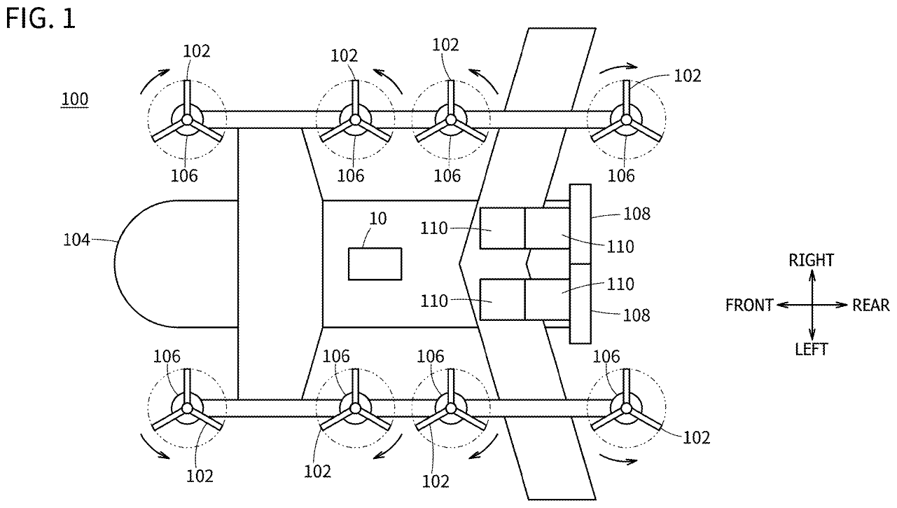

FIG. 1 is a schematic diagram of a moving object 100. The moving object 100 of an embodiment of the present disclosure is an electric vertical take-off and landing aircraft (eVTOL aircraft). The moving object 100 includes eight VTOL rotors 102. The VTOL rotors 102 generate upward thrust for a fuselage 104. The moving object 100 includes eight electric motors 106. One electric motor 106 drives one VTOL rotor 102. The moving object 100 includes two cruise rotors 108. The cruise rotors 108 generate forward thrust for the fuselage 104. The moving object 100 includes four electric motors 110. Two electric motors 110 drive one cruise rotor 108. The moving object 100 includes one or more power supply systems 10. The moving object 100 is not limited to being an aircraft, but may be a ship, an automobile, a train, or the like.

### 2. Configuration of Power Supply System 10

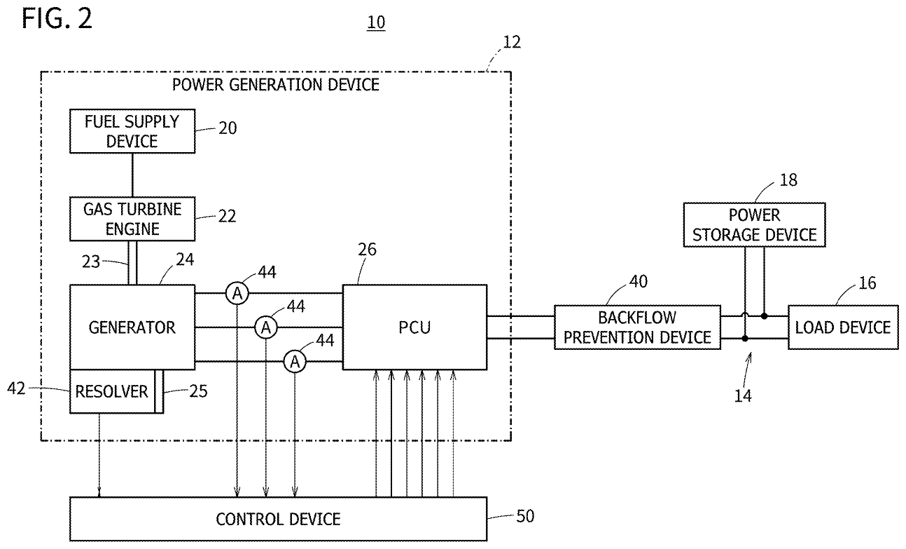

FIG. 2 is a schematic diagram of the power supply system 10. The power supply system 10 is provided in the moving object 100. In the power supply system 10, electric power can be supplied from a power generation device 12 to a load device 16 and a power storage device 18 via a power supply circuit 14. Further, in the power supply system 10, electric power can be supplied from the power storage device 18 to the load device 16. Furthermore, in the power supply system 10, in the case where a backflow prevention device 40 is in a state of allowing backflow, electric power can be supplied from the power storage device 18 to the power generation device 12.

The power supply system 10 includes the power generation device 12. The power generation device 12 includes a fuel supply device 20, a gas turbine engine (an internal combustion engine) 22, a generator (a rotating electric machine) 24, and a PCU 26. The fuel supply device 20 includes a fuel tank, an electric pump, and a shut-off valve (none of which are shown). The electric pump supplies fuel sucked from the fuel tank, to a combustor of the gas turbine engine 22. The gas turbine engine 22 includes a compressor, the combustor, and a turbine (none of which are shown). An output shaft 23 of the gas turbine engine 22 is connected to a rotating shaft 25 of the generator 24. The rotating shaft 25 of the generator 24 is connected to a rotor (not shown). The generator 24 is a motor generator that can also function as an electric motor. The rotor of the generator 24 rotates in accordance with the rotation of the output shaft 23 of the gas turbine engine 22. As a result, the generator 24 outputs, for example, three-phase AC power.

The PCU 26 can function as an AC-DC converter and an inverter. The AC terminals of the PCU 26 are connected to the output terminals of the generator 24. The DC terminals of the PCU 26 are connected to the power supply circuit 14. The PCU 26 can convert the three-phase AC power input from the AC terminals into DC power and output the DC power to the power supply circuit 14 connected to the DC terminals. Further, the PCU 26 can convert the DC power input from the DC terminals into three-phase AC power and output the three-phase AC power to the generator 24 connected to the AC terminals. Furthermore, the PCU 26 can convert electric power stored in a smoothing capacitor 30 into three-phase AC power and output the three-phase AC power to the generator 24 connected to the AC terminals.

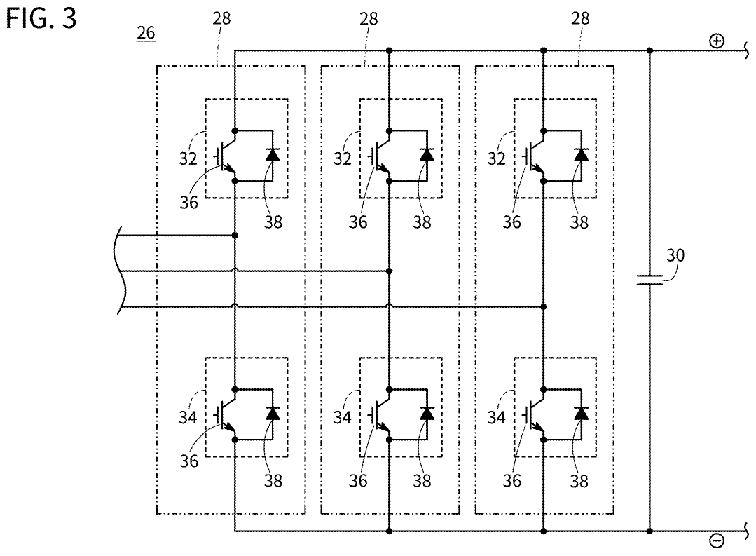

FIG. 3 is a circuit diagram of the PCU 26. The PCU 26 includes three power element units 28 corresponding to respective phases of the three-phase voltage output from the generator 24, and the smoothing capacitor 30. The three power element units 28 have the same configuration.

The power element units 28 each include an upper arm 32 and a lower arm 34. Each of the upper arm 32 and the lower arm 34 includes a switching element 36 and a diode 38. In the power element unit 28, the switching element 36 of the upper arm 32 and the switching element 36 of the lower arm 34 are connected in series to each other. A first end portion of the switching element 36 of the upper arm 32 is connected to a positive wire of the PCU 26. A second end portion of the switching element 36 of the upper arm 32 and a first end portion of the switching element 36 of the lower arm 34 are connected to one of the output terminals of the generator 24. A second end portion of the switching element 36 of the lower arm 34 is connected to a negative wire of the PCU 26. The anode of the diode 38 is connected to the second end portion of the switching element 36. The cathode of the diode 38 is connected to the first end portion of the switching element 36.

Referring back to FIG. 2, the description will be continued. The power supply system 10 includes the load device 16. The load device 16 includes one or more electric motors 106 and one or more electric motors 110 shown in FIG. 1. An inverter (not shown) is connected to each of the electric motors 106 and each of the electric motors 110. The inverter converts the input DC power into three-phase AC power. The electric motors 106 and the electric motors 110 are driven by the three-phase AC power. The load device 16 may include a DC-DC converter and a low-voltage drive device (neither of which is shown).

The power supply system 10 includes the power storage device 18. The power storage device 18 is connected to the power supply circuit 14 in parallel with the PCU 26. The power storage device 18 includes a storage battery (for example, a lithium ion battery).

The power supply system 10 includes the backflow prevention device 40. The backflow prevention device 40 is disposed in the power supply circuit 14. The backflow prevention device 40 limits the supply of electric power from the power storage device 18 to the power generation device 12. The backflow prevention device 40 includes a diode (not shown). Furter, the backflow prevention device 40 includes a transistor (not shown) that bypasses the diode. The transistor allows the supply of electric power from the power storage device 18 to the power generation device 12, for example, by being supplied with an ON signal.

The power supply system 10 includes a resolver 42 and three current sensors 44. The resolver 42 detects the rotation angle of the rotating shaft 25 of the generator 24. Each current sensor 44 detects any one of three phase currents flowing from one of the generator 24 and the PCU 26 to the other of thereof. Note that, if two phase currents are known, the remaining one phase current can be calculated. Therefore, the power supply system 10 may include two current sensors 44.

### 3. Control Device 50

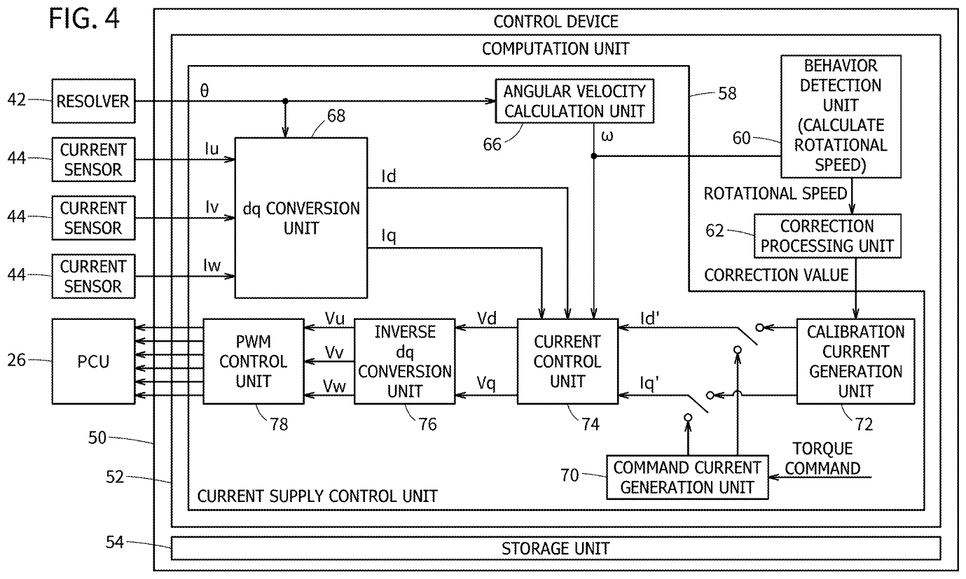

The power supply system 10 includes a control device 50. FIG. 4 is a block diagram of the control device 50. The control device 50 is constituted by, for example, an electronic control unit (ECU).

The control device 50 includes a computation unit 52 and a storage unit 54. The computation unit 52 is, for example, a processor such as a central processing unit (CPU) or a graphics processing unit (GPU). The computation unit 52 includes a current supply control unit 58, a behavior detection unit 60, and a correction processing unit 62. The current supply control unit 58, the behavior detection unit 60, and the correction processing unit 62 are realized by the computation unit 52 executing a program stored in the storage unit 54. At least part of the current supply control unit 58, the behavior detection unit 60, and the correction processing unit 62 may be realized by an integrated circuit such as an application specific integrated circuit (ASIC) or a field-programmable gate array (FPGA). At least part of the current supply control unit 58, the behavior detection unit 60, and the correction processing unit 62 may be realized by an electronic circuit including a discrete device.

The storage unit 54 is a non-transitory computer-readable tangible storage medium. The storage unit 54 is constituted by a volatile memory (not shown) and a non-volatile memory (not shown). The volatile memory is, for example, a random access memory (RAM) or the like. The non-volatile memory is, for example, a read only memory (ROM), a flash memory, or the like. Data and the like are stored in, for example, the volatile memory. A program, a table, a map, and the like are stored in, for example, the non-volatile memory. At least part of the storage unit 54 may be included in the processor, the integrated circuit, or the like described above.

The current supply control unit 58 performs current control (vector control) of the generator 24. The current supply control unit 58 functions as an angular velocity calculation unit 66, a dq conversion unit 68, a command current generation unit 70, a calibration current generation unit 72, a current control unit 74, an inverse dq conversion unit 76, and a PWM control unit 78.

The angular velocity calculation unit 66 calculates an angular velocity (ω) of the rotating shaft 25 of the generator 24 based on a rotation angle (θ) detected by the resolver 42. The dq conversion unit 68 calculates a d-axis current value (Id) and a q-axis current value (Iq) based on the rotation angle (θ) detected by the resolver 42 and phase current values (Iu, Iv, Iw) detected by the current sensors 44.

The command current generation unit 70 generates a d-axis current command value (Id′) and a q-axis current command value (Iq′). The command current generation unit 70 generates the current command values (Id′, Iq′) of the respective axes based on the torque command value acquired from a management ECU (not shown) that integrally manages a control system of the moving object 100 during normal current control.

The current control unit 74 calculates a d-axis voltage command value (Vd) and a q-axis voltage command value (Vq), which are values of the control voltage, based on the angular velocity (ω) calculated by the angular velocity calculation unit 66, the current values (Id, Iq) of the respective axes calculated by the dq conversion unit 68, and the current command values (Id′, Iq′) of the respective axes generated by the command current generation unit 70. The inverse dq conversion unit 76 calculates three phase voltage command values (Vu, Vv, Vw) based on the rotation angle (θ) detected by the resolver 42 and the voltage command values (Vd, Vq) of the respective axes calculated by the current control unit 74. The PWM control unit 78 performs pulse width modulation (PWM) control on the switching elements 36 provided in the PCU 26 based on the three phase voltage command values (Vu, Vv, Vw) calculated by the inverse dq conversion unit 76.

The current supply control unit 58 performs current control (vector control) for zero point correction. Specifically, the current supply control unit 58 performs d-axis current supply control, which is control of supplying a d-axis current to the generator 24 in a state where the rotating shaft 25 of the generator 24 is stopped. During the normal current control, the command current generation unit 70 is included in a part of the function of the current supply control unit 58, but during a zero point correction process, the calibration current generation unit 72 is included in a part of the function of the current supply control unit 58 instead of the command current generation unit 70. At the time of the d-axis current supply control, the calibration current generation unit 72 generates the current command values (Id′, Iq′) of the respective axes based on a correction value for a phase error acquired from the correction processing unit 62.

The behavior detection unit 60 detects the behavior of the rotating shaft 25 of the generator 24 when the d-axis current supply control is performed by the current supply control unit 58. Specifically, the behavior detection unit 60 calculates the rotational speed of the rotating shaft 25 based on the angular velocity (ω) of the rotating shaft 25 calculated by the angular velocity calculation unit 66. Further, the behavior detection unit 60 detects the rotation direction of the rotating shaft 25 of the generator 24.

The correction processing unit 62 performs a correction process of correcting the phase error of the resolver 42 according to the behavior of the rotating shaft 25 of the generator 24 detected by the behavior detection unit 60. At the time of a zero point correction process, the correction processing unit 62 outputs a correction value for the phase error to the calibration current generation unit 72 based on the rotational speed of the rotating shaft 25 of the generator 24.

### 4. Principles of Present Disclosure

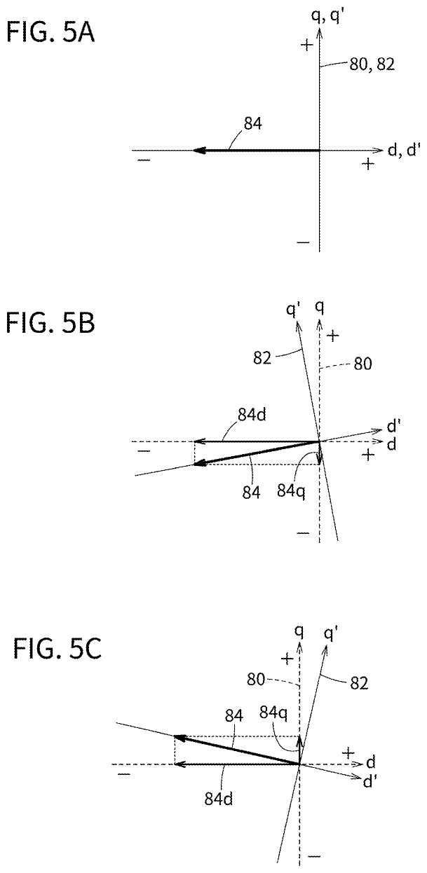

FIGS. 5A to 5C are diagrams showing an actual dq current vector plane 80 of the generator 24 and a dq current vector plane 82 recognized by the control device 50. In FIGS. 5A to 5C, the dq current vector plane 80 is represented by a d-axis indicated by d and a q-axis indicated by q. In addition, in FIGS. 5A to 5C, the dq current vector plane 82 is represented by a d-axis indicated by d′ and a q-axis indicated by q′. The control device 50 recognizes a reference point of the output signal of the resolver 42, and recognizes the dq current vector plane 82 corresponding to the reference point. The current supply control unit 58 performs vector control based on the dq current vector plane 82.

FIG. 5A shows the dq current vector plane 80 and the dq current vector plane 82 in a state where no phase error occurs in the resolver 42. On the other hand, FIGS. 5B and 5C show the dq current vector plane 80 and the dq current vector plane 82 in a state where a phase error has occurred in the resolver 42. Specifically, FIG. 5B shows the dq current vector plane 80 and the dq current vector plane 82 in a state where the rotation angle indicated by the output signal of the resolver 42 is advanced with respect to the actual rotation angle of the rotating shaft 25 of the generator 24. Further, FIG. 5C shows the dq current vector plane 80 and the dq current vector plane 82 in a state where the rotation angle indicated by the output signal of the resolver 42 is delayed with respect to the actual rotation angle of the rotating shaft 25 of the generator 24.

In this instance, a case is assumed in which vector control is performed when the generator 24 functions as a motor. A q-axis current (a current component in a q-axis direction) of the current supplied to the generator 24 contributes to generation of a torque. The positive q-axis current applies a positive torque to the rotating shaft 25 of the generator 24. As a result, the rotating shaft 25 of the generator 24 rotates in the normal direction. The negative q-axis current applies a negative torque to the rotating shaft 25 of the generator 24. As a result, the rotating shaft 25 of the generator 24 rotates in the reverse direction. On the other hand, a d-axis current (a current component in a d-axis direction) of the current flowing through the generator 24 does not contribute to the generation of a torque. In other words, in the case where only the d-axis current flows through the generator 24, the rotating shaft 25 of the generator 24 does not rotate.

In the state shown in FIG. 5A, in the case where the current supply control unit 58 performs control of supplying a current 84 (d-axis current) in the d-axis direction (here, a d-axis negative direction) to the generator 24 based on the dq current vector plane 82, the rotating shaft 25 of the generator 24 does not rotate. This is because the current 84 in the d-axis direction (here, the d-axis negative direction) in the dq current vector plane 82 has only a d-axis current component in the d-axis direction in the dq current vector plane 80.

In the state shown FIG. 5B, in the case where the current supply control unit 58 performs control of supplying the current 84 (d-axis current) in the d-axis direction (here, the d-axis negative direction) to the generator 24 based on the dq current vector plane 82, the rotating shaft 25 of the generator 24 rotates in the reverse direction. This is because the current 84 in the d-axis direction (here, the d-axis negative direction) in the dq current vector plane 82 has a q-axis current component 84q in a q-axis negative direction.

In the state shown FIG. 5C, in the case where the current supply control unit 58 performs control of supplying the current 84 (d-axis current) in the d-axis direction (here, the d-axis negative direction) to the generator 24 based on the dq current vector plane 82, the rotating shaft 25 of the generator 24 rotates in the normal direction. This is because the current 84 in the d-axis direction (here, the d-axis negative direction) in the dq current vector plane 82 has the q-axis current component 84q in a q-axis positive direction.

In this manner, in a state where a phase error of the resolver 42 has occurred, in the case where only the current 84 in the d-axis direction is caused to flow based on the dq current vector plane 82, the rotating shaft 25 of the generator 24 rotates. The present disclosure utilizes this phenomenon to detect a phase error of the resolver 42 and perform the zero point correction.

### 5. Zero Point Correction Process

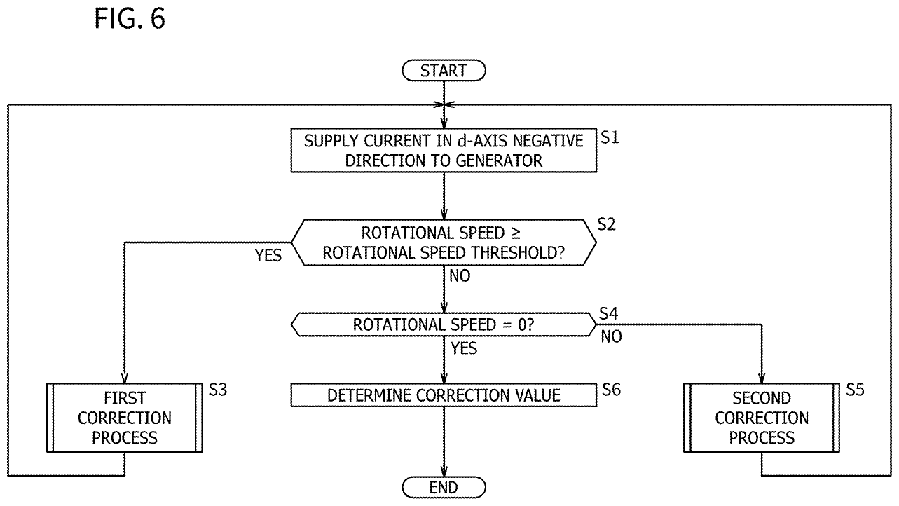

FIG. 6 is a flowchart of a zero point correction process. The zero point correction process is a phase error correction method. The zero point correction process is performed when the gas turbine engine 22 is stopped (for example, when the moving object 100 is stopped). In the following zero point correction process, a correction process of calculating a correction value used to eliminate a phase error of the resolver 42 is performed. It should be noted that, at the time point when the zero point correction process is started, the correction value is an initial value (zero).

When the following zero point correction process is performed, an ON signal is supplied from the control device 50 to the transistor included in the backflow prevention device 40 of the power supply system 10 shown in FIG. 2. As a result, the backflow prevention device 40 allows the supply of electric power from the power storage device 18 to the power generation device 12.

In step S1, in a state where the rotating shaft 25 of the generator 24 is stopped, the current supply control unit 58 performs the d-axis current supply control based on the dq current vector plane 82. In this instance, the current supply control unit 58 performs control of supplying only the current 84 (d-axis current) in the d-axis negative direction. The current supply control unit 58 outputs a control signal to the PCU 26. The PCU 26 converts DC power supplied thereto from the power storage device 18 into AC power and supplies the AC power to the generator 24. As a result, only the d-axis current in the d-axis negative direction in the dq current vector plane 82 is supplied to the generator 24.

In step S2, the behavior detection unit 60 detects the rotational speed of the rotating shaft 25. The angular velocity calculation unit 66 calculates the angular velocity of the rotating shaft 25 of the generator 24 based on the rotation angle detected by the resolver 42. The behavior detection unit 60 calculates the rotational speed of the rotating shaft 25 based on the angular velocity of the rotating shaft 25 of the generator 24 calculated by the angular velocity calculation unit 66. The behavior detection unit 60 compares the calculated rotational speed with a rotational speed threshold. The rotational speed threshold is stored in the storage unit 54 in advance. In the case where the rotational speed is equal to or greater than the rotational speed threshold (step S2: YES), the process proceeds to step S3. On the other hand, in the case where the rotational speed is less than the rotational speed threshold (step S2: NO), the process proceeds to step S4.

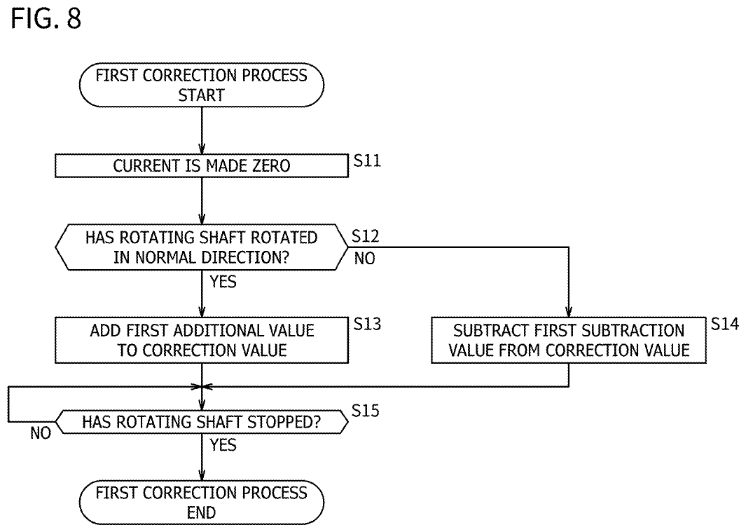

When the process proceeds from step S2 to step S3, a first correction process shown in FIG. 8 is performed. The first correction process will be described later. When the first correction process is ended, the process returns to step S1.

When the process proceeds from step S2 to step S4, the behavior detection unit 60 determines whether or not the rotational speed of the rotating shaft 25 of the generator 24 is 0. In the case where the rotational speed is 0 (step S4: YES), the process proceeds to step S6. On the other hand, in the case where the rotational speed is not 0 (step S4: NO), the process proceeds to step S5.

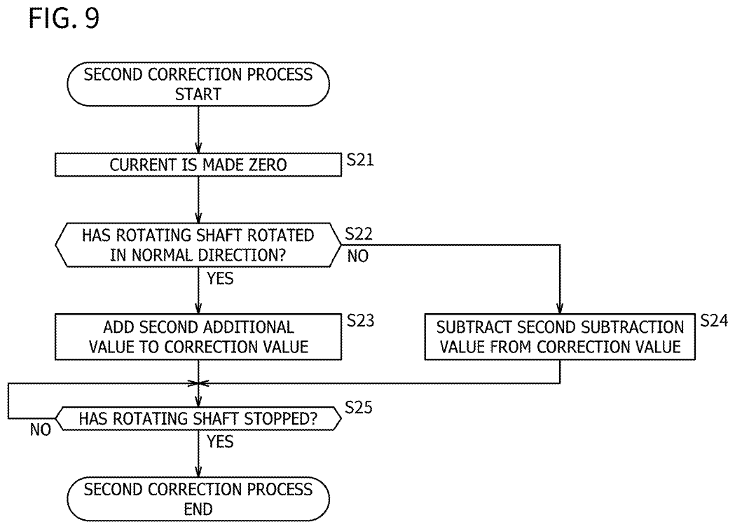

When the process proceeds from step S4 to step S5, a second correction process shown in FIG. 9 is performed. The second correction process will be described later. When the second correction process is ended, the process returns to step S1.

When the process proceeds from step S4 to step S6, the correction processing unit 62 determines, as a final correction value, a correction value stored in the storage unit 54 at that time point. The correction processing unit 62 corrects the zero point (reference point) recognized by the control device 50 with the correction value. The zero point correction is thus ended.

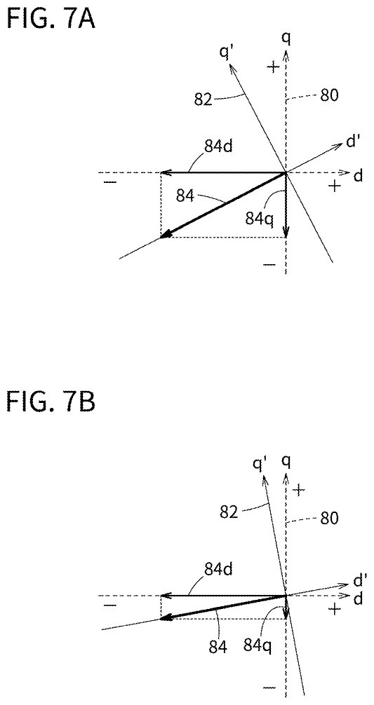

FIGS. 7A and 7B are diagrams showing the actual dq current vector plane 80 of the generator 24 and the dq current vector plane 82 recognized by the control device 50. FIG. 7A shows the dq current vector plane 80 and the dq current vector plane 82 in a state where the phase error of the resolver 42 is large. FIG. 7B shows the dq current vector plane 80 and the dq current vector plane 82 in a state where the phase error of the resolver 42 is small.

When the d-axis current supply control (step S1 in FIG. 6) is performed in the case where the relationship between the dq current vector plane 80 and the dq current vector plane 82 is in the state shown in FIG. 7A, the q-axis current component 84q becomes relatively large. As a result, the rotational speed of the rotating shaft 25 of the generator 24 becomes relatively high. In this case, the first correction process (FIG. 8) is performed. On the other hand, when the d-axis current supply control (step S1 in FIG. 6) is performed in the case where the relationship between the dq current vector plane 80 and the dq current vector plane 82 is in the state shown in FIG. 7B, the q-axis current component 84q becomes relatively small. As a result, the rotational speed of the rotating shaft 25 of the generator 24 becomes relatively low. In this case, the second correction process (FIG. 9) is performed.

FIG. 8 is a flowchart of the first correction process. The first correction process is performed in step S3 of the zero point correction process shown in FIG. 6. In the first correction process, the correction value for correcting the phase error of the resolver 42 is updated based on one d-axis current supply control (step S1 in FIG. 6). The first correction process corresponds to coarse adjustment of the correction value. As described above, the first correction process is performed in the case where the phase error of the resolver 42 is relatively large.

In step S11, the current supply control unit 58 performs control of making the current zero. The current supply control unit 58 outputs a control signal to the PCU 26. The PCU 26 sets the current supplied to the generator 24 to zero. As a result, the q-axis current that generates a torque is not supplied to the generator 24. The rotating shaft 25 of the generator 24 rotates for a while due to inertia, but stops due to the frictional force of a bearing (not shown).

In step S12, the behavior detection unit 60 determines the direction in which the rotating shaft 25 of the generator 24 has rotated by the d-axis current supply control performed in step S1 of the zero point correction process shown in FIG. 6. In the case where the rotating shaft 25 has rotated in the normal direction (step S12: YES), the process proceeds to step S13. On the other hand, in the case where the rotating shaft 25 has rotated in the reverse direction (step S12: NO), the process proceeds to step S14.

When the process proceeds from step S12 to step S13, the correction processing unit 62 adds a first additional value to the correction value. As shown in FIG. 5C, in the case where the rotation angle indicated by the output signal of the resolver 42 is delayed with respect to the actual rotation angle of the rotating shaft 25 of the generator 24, the rotating shaft 25 of the generator 24 rotates in the normal direction. In this case, the correction processing unit 62 adds the first additional value to the correction value in order to advance the rotation angle indicated by the output signal of the resolver 42. The first additional value is stored in the storage unit 54 in advance.

When the process proceeds from step S12 to step S14, the correction processing unit 62 subtracts a first subtraction value from the correction value. As shown in FIG. 5B, in the case where the rotation angle indicated by the output signal of the resolver 42 is advanced with respect to the actual rotation angle of the rotating shaft 25 of the generator 24, the rotating shaft 25 of the generator 24 rotates in the reverse direction. In this case, the correction processing unit 62 subtracts the first subtraction value from the correction value in order to delay the rotation angle indicated by the output signal of the resolver 42. The first subtraction value is stored in the storage unit 54 in advance.

In step S15, the behavior detection unit 60 determines whether or not the rotating shaft 25 of the generator 24 has stopped. When the current supplied to the generator 24 is made zero in step S11, the rotating shaft 25 eventually stops. In the case where the rotating shaft 25 has stopped (step S15: YES), the first correction process is ended. In this case, the process returns to step S1 of the zero point correction process shown in FIG. 6. On the other hand, in the case where the rotating shaft 25 has not stopped (step S15: NO), the process of step S15 is performed again. The determination of step S15 is repeatedly performed until the rotating shaft 25 of the generator 24 stops.

FIG. 9 is a flowchart of the second correction process. The second correction process is performed in step S5 of the zero point correction process shown in FIG. 6. In the second correction process, the correction value for correcting the phase error of the resolver 42 is updated based on one d-axis current supply control (step S1 in FIG. 6). The second correction process corresponds to fine adjustment of the correction value. As described above, the second correction process is performed in the case where the phase error of the resolver 42 is relatively small.

The second correction process is the same as the first correction process except for the additional value and the subtraction value for the correction value. Therefore, the description of the second correction process will be omitted. A second additional value in step S23 is a value smaller than the first additional value in step S13. Similarly, a second subtraction value in step S24 is a value smaller than the first subtraction value in step S14. The second additional value and the second subtraction value are stored in the storage unit 54 in advance.

In the zero point correction process (including the first correction process and the second correction process) shown in FIG. 6, the d-axis current supply control by the current supply control unit 58, the detection of the behavior of the rotating shaft 25 by the behavior detection unit 60, and the correction process by the correction processing unit 62 are sequentially repeated until the rotational speed of the rotating shaft 25 of the generator 24 becomes zero by the d-axis current supply control.

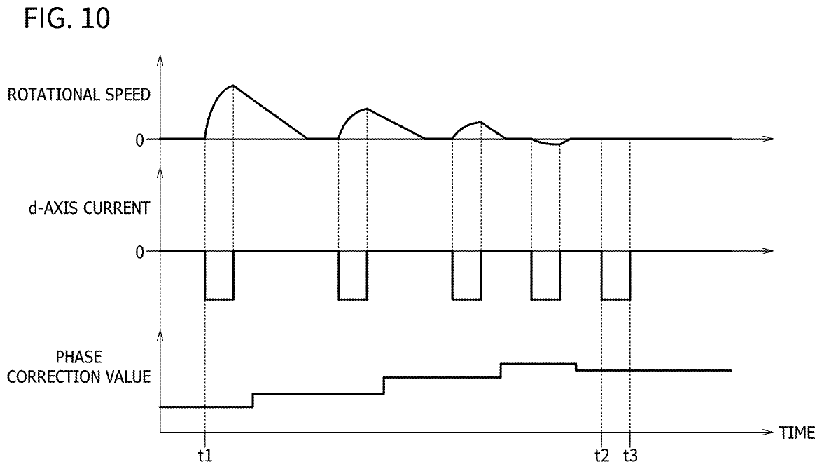

FIG. 10 is a time chart of the rotational speed of the rotating shaft 25 of the generator 24, the d-axis current, and the correction value (a phase correction value). At a time point t1, the zero point correction process is started. When the zero point correction process is performed in a state where a phase error has occurred in the resolver 42, at least one of the first correction process or the second correction process is performed once or more. The correction value is updated each time either the first correction process or the second correction process is performed. Even if the d-axis current supply control is performed at a time point t2 (> the time point t1), the rotating shaft 25 does not rotate. Therefore, the zero point correction process is ended at a time point t3 (> the time point t2). The correction value at the time point t3 is set as a final correction value.

According to the present embodiment, the phase error of the resolver 42 can be eliminated in a state where the rotational speed of the rotating shaft 25 of the generator 24 is made zero.

### 6. Modification

### 6-1. Modification 1

In the zero point correction process shown in FIG. 6, depending on whether or not the rotational speed of the rotating shaft 25 is equal to or greater than the rotational speed threshold, one of the first additional value or the second additional value is selected as the additional value, and one of the first subtraction value or the second subtraction value is selected as the subtraction value. Instead of this feature, a table, a map, or the like in which the additional value and the subtraction value are associated with the rotational speed of the rotating shaft 25 may be used. Alternatively, a calculation formula for calculating the additional value and the subtraction value from the rotational speed of the rotating shaft 25 may be used.

### 6-2. Modification 2

In step S11 of FIG. 8 and step S21 of FIG. 9, the current supply control unit 58 may perform control of braking the rotating shaft 25. For example, the current supply control unit 58 may perform control of supplying, to the generator 24, a current that generates a torque in a direction opposite to the direction in which the rotating shaft 25 rotates.

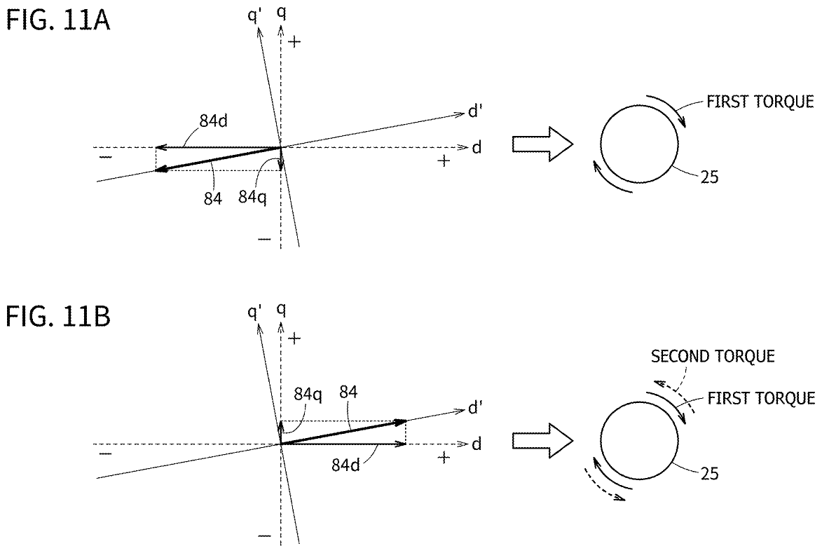

FIGS. 11A and 11B are diagrams showing a torque generated in the generator 24. In step S1 of FIG. 6, the current supply control unit 58 performs the d-axis current supply control of supplying only the current 84 (d-axis current) in the d-axis negative direction. As shown in FIG. 11A, when the current supply control unit 58 performs the d-axis current supply control in a state where a phase error of the resolver 42 has occurred, the q-axis current component 84q in the negative direction is generated in the generator 24, for example. Therefore, a first torque is generated in the rotating shaft 25 of the generator 24. Then, the rotating shaft 25 rotates in the direction of the first torque.

In step S11 of FIG. 8 and step S21 of FIG. 9, the current supply control unit 58 performs braking current supply control of supplying only the current 84 (d-axis current) in the d-axis positive direction. As shown in FIG. 11B, when the current supply control unit 58 performs the braking current supply control in a state where a phase error of the resolver 42 has occurred, the q-axis current component 84q in the positive direction is generated in the generator 24, for example. Therefore, a second torque in the opposite direction to the first torque is generated in the rotating shaft 25 of the generator 24. This second torque brakes the rotating shaft 25. Then, the rotating shaft 25 stops.

According to the second modification, the current supply control unit 58 applies the second torque to the rotating shaft 25, thereby reducing the time required for the rotating shaft 25 to stop. This makes it possible to shorten the execution time of the zero point correction process.

### 6-3. Modification 3

The current supply control unit 58 may perform the control of the second modification (the braking current supply control) in the case where the rotational speed of the rotating shaft 25 reaches a predetermined limit value within a predetermined time.

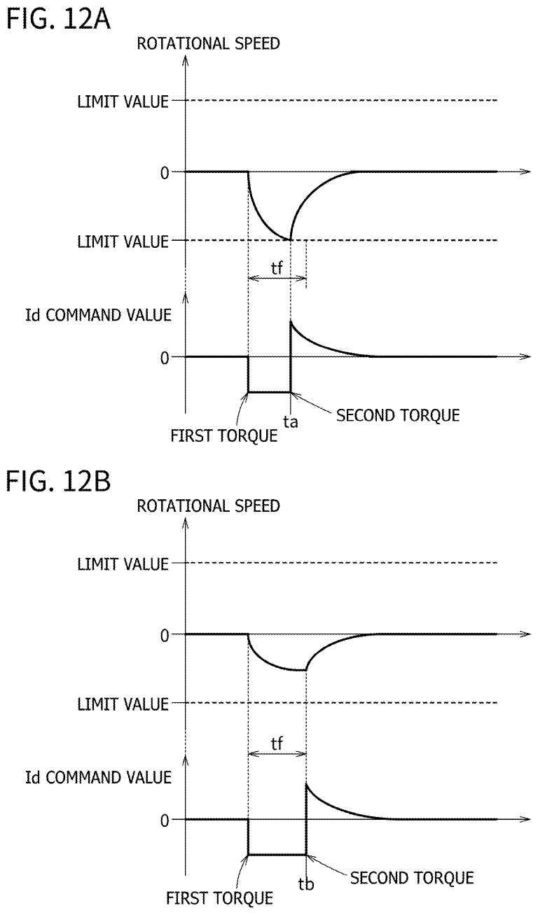

As shown in FIG. 12A, the rotational speed of the rotating shaft 25 reaches an absolute value of the limit value at a time point ta before a predetermined time tf elapses after the first torque is applied to the rotating shaft 25 by the d-axis current supply control. In this case, the current supply control unit 58 performs the braking current supply control. As a result, the second torque is applied to the rotating shaft 25, and the rotating shaft 25 stops.

As shown in FIG. 12B, the rotational speed of the rotating shaft 25 does not reach the absolute value of the limit value until the predetermined time tf elapses after the first torque is applied to the rotating shaft 25 by the d-axis current supply control. In this case, the current supply control unit 58 performs the braking current supply control at a time point tb when the predetermined time tf has elapsed. As a result, the second torque is applied to the rotating shaft 25, and the rotating shaft 25 stops.

According to the third modification, it is possible to suppress the over-rotation of the rotating shaft 25.

The above-described embodiment and modifications can be used even when the rotating electric machine is an electric motor instead of the generator 24.

Note that, in the above disclosure, it is important that the rotating shaft 25 of the generator 24 can be rotated by the d-axis current supply control. In a system in which a heavy load is connected to the rotating shaft 25 of the generator 24, the rotating shaft 25 does not rotate even if the d-axis current supply control is performed. The above disclosure cannot be used in such a system.

### 7. Supplementary Notes

The following supplementary notes are further disclosed in relation to the above-described embodiment.

### Supplementary Note 1

The control device (50) of the present disclosure is a control device that controls the rotating electric machine (24) provided with the resolver (42) configured to detect the rotation angle of the rotating shaft (25), the control device including: the current supply control unit (58) configured to perform d-axis current supply control that is control of supplying the d-axis current to the rotating electric machine in a state where the rotating shaft is stopped; the behavior detection unit (60) configured to detect the behavior of the rotating shaft when the d-axis current supply control is performed; and the correction processing unit (62) configured to perform, according to the behavior detected by the behavior detection unit, the correction process of correcting a phase error between the actual rotation angle of the rotating shaft and the rotation angle of the rotating shaft indicated by the output signal of the resolver.

According to the above configuration, the phase error of the resolver can be eliminated in a state where the rotational speed of the rotating shaft of the rotating electric machine is made zero.

### Supplementary Note 2

In the control device according to Supplementary Note 1, the behavior detection unit may detect the rotational speed of the rotating shaft based on the rotation angle of the rotating shaft detected by the resolver, and the d-axis current supply control by the current supply control unit, the detection of the behavior of the rotating shaft by the behavior detection unit, and the correction process by the correction processing unit may be sequentially repeated until the rotational speed of the rotating shaft when the d-axis current supply control is performed becomes zero.

### Supplementary Note 3

In the control device according to Supplementary Note 2, the current supply control unit may perform control of braking the rotating shaft in the case where the behavior detection unit detects rotation of the rotating shaft.

According to the above configuration, it is possible to reduce the time required for the rotating shaft to stop.

### Supplementary Note 4

In the control device according to Supplementary Note 2, the correction processing unit may determine the correction value for the phase error based on the rotational speed of the rotating shaft.

### Supplementary Note 5

In the control device according to Supplementary Note 2, the current supply control unit may perform control of braking the rotating shaft in the case where the rotational speed of the rotating shaft reaches the predetermined limit value within the predetermined time.

According to the above configuration, it is possible to suppress over-rotation of the rotating shaft.

### Supplementary Note 6

In the control device according to Supplementary Note 1, the rotating electric machine may be a generator configured to be driven by the internal combustion engine (22).

### Supplementary Note 7

The phase error correction method of the present disclosure is a phase error correction method for correcting a phase error between the actual rotation angle of the rotating shaft of the rotating electric machine and the rotation angle of the rotating shaft indicated by the output signal of the resolver, the phase error correction method including: the control step of causing one or more processors to perform d-axis current supply control that is control of supplying the d-axis current to the rotating electric machine in a state where the rotating shaft is stopped; the detection step of causing the one or more processors to detect the behavior of the rotating shaft when the d-axis current supply control is performed; and the correction step of causing the one or more processors to perform the correction process of correcting the phase error according to the behavior detected in the detection step.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A control device that controls a rotating electric machine provided with a resolver configured to detect a rotation angle of a rotating shaft, the control device comprising:
one or more processors that execute computer-executable instructions stored in a memory,
wherein the one or more processors execute the computer-executable instructions to cause the control device to:
perform d-axis current supply control that is control of supplying a d-axis current to the rotating electric machine in a state where the rotating shaft is stopped;
detect a behavior of the rotating shaft when the d-axis current supply control is performed; and
perform, according to the behavior that has been detected, a correction process of correcting a phase error between an actual rotation angle of the rotating shaft and a rotation angle of the rotating shaft indicated by an output signal of the resolver.

2. The control device according to claim 1, wherein
the one or more processors cause the control device to:
detect a rotational speed of the rotating shaft based on the rotation angle of the rotating shaft detected by the resolver; and
sequentially repeat the d-axis current supply control, detection of the behavior of the rotating shaft, and the correction process, until the rotational speed of the rotating shaft when the d-axis current supply control is performed becomes zero.

3. The control device according to claim 2, wherein
the one or more processors cause the control device to perform control of braking the rotating shaft in a case where rotation of the rotating shaft is detected.

4. The control device according to claim 2, wherein
the one or more processors cause the control device to determine a correction value for the phase error based on the rotational speed of the rotating shaft.

5. The control device according to claim 2, wherein
the one or more processors cause the control device to perform control of braking the rotating shaft in a case where the rotational speed of the rotating shaft reaches a predetermined limit value within a predetermined time.

6. The control device according to claim 1, wherein
the rotating electric machine is a generator configured to be driven by an internal combustion engine.

7. A phase error correction method for correcting a phase error between an actual rotation angle of a rotating shaft of a rotating electric machine and a rotation angle of the rotating shaft indicated by an output signal of a resolver, the phase error correction method comprising:
causing one or more processors to perform d-axis current supply control that is control of supplying a d-axis current to the rotating electric machine in a state where the rotating shaft is stopped;
causing the one or more processors to detect a behavior of the rotating shaft when the d-axis current supply control is performed; and
causing the one or more processors to perform a correction process of correcting the phase error according to the behavior that has been detected in the detecting of the behavior of the rotating shaft.
